(19) United States
(12) Patent Application Publication
(10) Pub. No.: US 2003/0173492 A1
(43) Pub. Date: Sep. 18, 2003

(54) Resin molded product and mold for molding a resin

(76) Inventor: Shigeru Kajiyama, Shizuoka (JP)

Correspondence Address: FISH & RICHARDSON P.C., 45 ROCKEFELLER PLAZA, SUITE 2800, NEW YORK, NY, 10111, US

(21) Appl. No.: 10/386,628

(22) Filed: Mar. 12, 2003

(30) Foreign Application Priority Data
Mar. 12, 2002 (JP) P.2002-066827

(51) Int. Cl. B29C 33/40; F21V 1/00

(52) U.S. Cl. 249/160; 264/162; 264/163; 362/317

(57) ABSTRACT

The invention permits a boundary between a grained surface and a smooth surface to be seen clearly in a resin molded product, and facilitates manufacture and grinding of a mold for molding a resin. In an implementation, a resin molded product has a smooth surface adjacent to a grained surface on which microscopic asperities are formed. A step surface protruding toward the grained surface is formed on a boundary between the grained surface and the smooth surface.

### BACKGROUND OF THE INVENTION

1. Technical Field

The present invention relates to a novel resin molded product and a mold for molding a resin. More particularly, the present invention relates to an art which allows a boundary between a grained surface and a smooth surface to be clearly seen, and which facilitates manufacture and grinding of the mold for molding a resin.

2. Related Art

There is a resin molded product having a grained surface on which microscopic asperities are formed, that is, grain is formed, and a smooth surface on which grain is not formed (in the specification, a surface on which grain is not formed is referred to as a smooth surface in contrast to a grained surface), that are adjacently formed. For example, there is a vehicle lamp in which a grained surface is provided on a periphery of a translucent portion (a smooth surface) that occupies most of a front cover (lens) covering a front surface of a concave portion with a light source of a lamp body arranged, for the purpose of fulfilling a design requirement and of diffusing light.

Also, in a conventional resin molded product, when the grained surface and the smooth surface are adjacently provided, the grained surface and the smooth surface are adjacently provided in the same plane surface.

In the conventional resin molded product, there has been a problem that a boundary between a grained surface and a smooth surface cannot be seen clearly. Also, there has been another problem that manufacture of a mold is difficult.

When manufacturing a mold for molding a resin molded product such as the above-mentioned product, of the two portions arranged on the same flat surface, a portion which becomes a smooth surface transferring surface is masked. Then, the other portion which is not masked, that is, a portion which becomes a grain processing surface is formed into a grain processing surface by forming microscopic asperities by etching. Accordingly, the portion which is masked is not etched by an etchant and remains as a flat surface so as to become the smooth surface transferring surface. A mold for molding a resin molded product whose production volume is relatively small is normally manufactured as a one-off product. Accordingly, the above-mentioned masking process is performed by attaching a masking tape by hand.

As mentioned above, the boundary between the grained surface and the smooth surface transferring surface is defined by an edge of the masking tape. Also, attachment of the masking tape is likely to be incomplete, or even the attachment of the masking tape is complete, completely preventing the etchant from entering between the masking tape and the portion which becomes the smooth surface transferring surface is difficult, due to a characteristic of the masking tape. Therefore, it is difficult to form a parting line on the boundary between the grain processing surface and the smooth surface transferring surface. As a result, there arises a problem that the boundary between the grained surface and the smooth surface on the resin molded product which is formed using such a mold for molding a resin is seen vaguely instead of being seen clearly.

Also, when the resin molded product is the above-mentioned front cover for a vehicle lamp, and a smooth surface thereof is a translucent portion which allows light to pass there through, the smooth surface transferring portion of the mold needs to be mirror-finished. As a matter of course, even when the resin molded product is not the front cover for the vehicle lamp, in order to form the smooth surface into a glossy surface, the smooth surface transferring portion of the mold needs to be mirror-finished. Therefore, when manufacturing the mold, the smooth surface transferring surface needs to be ground. When the smooth surface transferring surface and the grain processing surface are arranged in the same plane surface, there is a possibility that the grain processing surface is also ground accidentally at the time of grinding. For example, when a resin material such as polycarbonate which generates gas at the time of injection is used, the smooth surface transferring surface needs to be ground on a daily basis, which increases a possibility of damaging the grain processing surface.

### SUMMARY OF THE INVENTION

The present invention provides an art which allows the boundary between the grained surface and the smooth surface to be seen clearly, and which facilitates manufacture and grinding of the mold for molding a resin.

In order to solve the above-mentioned problem, in a resin molded product according to the present invention, a step surface which protrudes toward a grained surface is formed on a boundary between a grained surface and the smooth surface.

Accordingly, in the resin molded product according to the present invention, the step surface arranged on the boundary between the grained surface and the smooth surface allows the boundary to be seen clearly.

Also, in the mold for molding a resin according to the present invention, a step surface which protrudes toward a smooth surface transferring surface is formed on a boundary between a grain processing surface for transferring the grained surface and the smooth surface transferring surface for transferring the smooth surface.

Accordingly, in the mold for molding a resin according to the present invention, when forming the grain processing surface, an end edge of a portion which becomes the smooth surface transferring surface on a side of the grain processing surface is at a position higher than the grain processing surface through the step surface. The etchant used for etching microscopic asperities on the grain processing surface is prevented from flowing into the portion which becomes the smooth surface transferring surface by the step surface. Therefore, the following state can be avoided with reliability; the boundary between the smooth surface transferring surface and the grain processing surface becomes vague because the end edge portion of the portion which becomes the smooth surface transferring surface on the side of the grain processing surface is etched even a masking tape is manually applied to the portion which becomes the smooth surface transferring surface.

Also, when grinding the smooth surface transferring surface by hand, since there exists a step surface, which is elevated toward the smooth surface transferring surface, between the smooth surface transferring surface and the grain processing surface, the boundary of an area which is to be ground can be sensed by the touch with reliability. Accordingly, accidental grinding of the grain processing surface can be avoided with reliability.

Hereafter, an embodiment of a resin molded product and a mold for molding a resin according to the present invention will be explained with reference to accompanying drawings.

### BRIEF DESCRIPTION OF THE DRAWINGS

FIG. 1 is a front view showing an embodiment of a resin molded product according to the present invention.

FIG. 2 is an enlarged sectional view showing a portion taken along line II-II shown in FIG. 1, and an enlarged sectional view showing a portion of the mold for molding a resin for molding the portion.

FIG. 3 is an enlarged sectional view showing a main portion of each modified example of the resin molded product and the mold for molding a resin.

### DETAILED DESCRIPTION

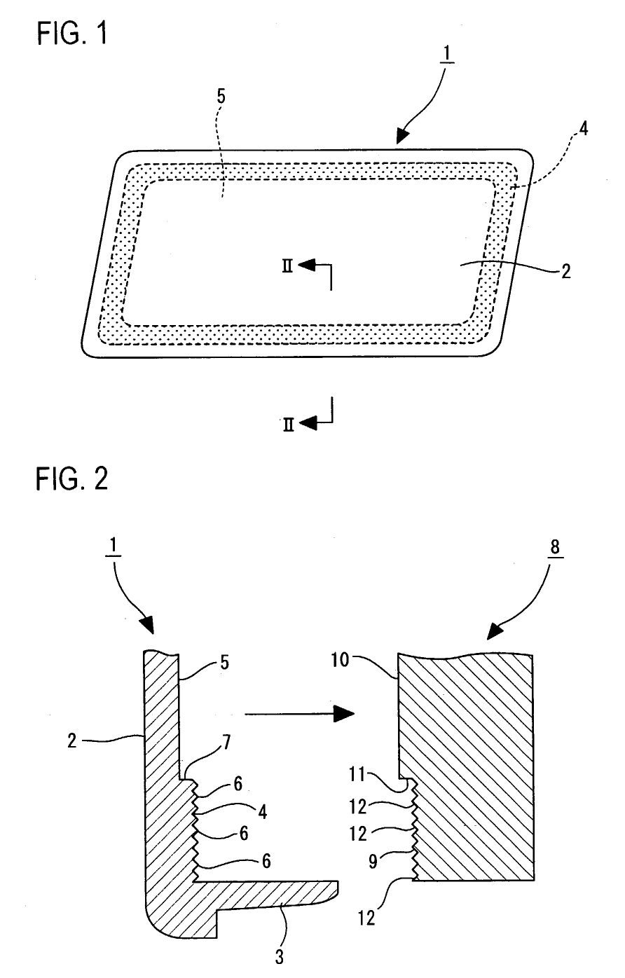

FIG. 1 and FIG. 2 show an example 1 of a resin molded product. The resin molded product 1 is a front cover (lens) for a vehicle lamp to which the present invention is applied. The front cover 1 is configured by integrally forming a front portion 2 which is in a substantially flat plate shape, and a peripheral wall portion 3 which protrudes rearward from a periphery of the front portion 2. In an inner surface of the front portion 2, a periphery portion 4 with a constant width protrudes inward with respect to a portion 5 which is on an inner side of the periphery portion 4. The periphery portion 4 is a grained surface, and microscopic asperities, that is, grain 6, 6, . .(it should be noted that a height (or a depth) of the grain is several μm to several hundred μm, and this is shown in an exaggerated form in the drawing) are formed on the periphery portion 4. The portion 5 which is on the inner side of the grained surface 4 is a smooth surface. As mentioned above, the grained surface 4 protrudes inward with respect to the smooth surface 5, and a step surface 7 protrudes toward the grained surface 4 on a boundary portion between the grained surface 4 and the smooth surface 5. The height of the step surface 7 (the amount of protrusion with respect to the smooth surface 5) is 0.01 mm to 0.3 mm. There exists a problem that when the height of the step surface is at or less than 0.01 mm, the boundary between the grained surface 4 and the smooth surface 5 is not clear. Alternatively, when the height of the step surface is at or more than 0.3 mm, a large amount of refracted light is generated and uncontrollably passes through the step surface 7, and this light becomes a glare light.

In the above-mentioned resin molded product 1, since the step surface 7 is formed on the boundary between the grained surface 4 and the smooth surface 5, the boundary between the grained surface 4 and the smooth surface 5 can be seen clearly, which makes the resin molded product 1 look attractive.

FIG. 2 shows a main portion of a mold 8 for molding a resin for forming the resin molded product 1.

In the mold 8 for molding a resin, a grain processing surface 9 for transferring the grained surface, and a smooth surface transferring surface 10 for transferring the smooth surface are adjacently formed. A step surface 11 is formed between the grain processing surface 9 and the smooth surface transferring surface 10, and the step surface 11 protrudes toward the smooth surface transferring surface 10. Namely, an end edge of the smooth surface transferring surface 10, which is adjacent to the step surface 11, is at a position higher than an end surface of the grain processing surface 9, which is adjacent to the step surface 11.

Microscopic asperities 12, 12, . . . (the depth (or a height) of the microscopic asperities 12, 12, . . . is several μm to several hundred μm, and this is shown in an exaggerated form in the drawing) are formed on the grain processing surface 9. Also, the height of the step surface 11 (an amount of protrusion with respect to the grain processing surface 9) is 0.01 mm to 0.3 mm.

The microscopic asperities 12, 12, . . . are formed by, for example, etching. The microscopic asperities 12, 12, . . . must not be formed on the smooth surface transferring surface 10. Thus, the smooth surface 10 is masked, and the grain processing surface 9 is exposed to the etchant. The microscopic asperities 12, 12, . . . are then formed by corrosion action of the etchant. The masking is performed by attaching masking tape to the smooth surface transferring surface 10 by hand.

In the mold 8 for molding a resin, the smooth surface transferring surface 10 is at a position higher than the grain processing surface 9 through the step surface 11. Thus, when the grain processing surface 9 is exposed to the etchant with the masking tape attached to the smooth surface transferring surface 10, it is difficult for the etchant to move toward the smooth surface transferring surface 10. Accordingly, there is almost no possibility that the smooth surface transferring surface 10 is etched by the etchant.

Also, when grinding the smooth surface transferring surface 10 by hand, there exists the step surface 11, which is elevated toward the smooth surface transferring surface 10. Thus, there is a boundary area between the smooth surface transferring surface 10 and the grain processing surface 9 that can be sensed with reliability by the sense of touch. Accordingly, accidentally grinding the grain processing surface 9 can be avoided with reliability.

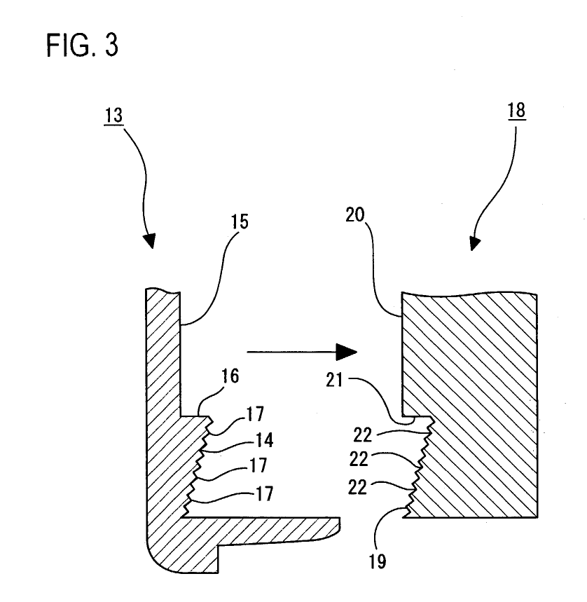

FIG. 3 shows modified examples of a resin molded product and a mold for molding a resin according to the present invention.

In a resin molded product 13 according to the modified example as well, a step surface 16 which protrudes toward a grained surface 14 is formed on the boundary between the grained surface 14 and a smooth surface 15. Also, microscopic asperities are formed, that is, grain 17, 17, . . . is formed on the grained surface 14.

In the modified examples, although an end edge of the grained surface 14, which is on a side of the step surface 16, protrudes rearward with respect to the smooth surface 15, the grained surface 14 is inclined forward with an increase in distance from the step surface 16.

Also, in the resin molded product 13, the step surface 16 is formed on the boundary between the grained surface 14 and the smooth surface 15. Thus, the boundary between the grained surface 14 and the smooth surface 15 can be seen clearly, which makes the resin molded product look attractive.

In a mold 18 for molding a resin according to the modified example, a grain processing surface 19 for transferring the grained surface and a smooth surface transferring surface 20 for transferring the smooth surface are adjacently formed. A step surface 21 which protrudes towards the smooth surface transferring surface 20 is formed between the grain processing surface 19 and the smooth surface transferring surface 20. Namely, an end edge of the smooth surface transferring surface 20, which is adjacent to the step surface 21, protrudes with respect to an end surface of the grain processing surface 19, which is adjacent to the step surface 21.

The end surface of the grain processing surface 19, which is on a side of the step surface 21, is at a position lower than the smooth surface transferring surface 20. However, the grain processing surface 19 is inclined so as to protrude toward a side where the smooth surface transferring surface 20 is positioned with an increase in distance from the step surface 21. Microscopic asperities 22, 22, . . . are then formed on the grain processing surface 19.

Note that, in the modified examples 13, 18, each size of the grain 17, 17, . . . , the microscopic asperities 22, 22, . . . , and the step surfaces 16, 21 is the same as each size thereof in the above-mentioned embodiments 1, 8.

In the mold 18 for molding a resin, the smooth surface transferring surface 20 is at a position higher than the grain processing surface 19 through the step surface 21. Accordingly, when the grain processing surface 19 is exposed to the etchant with the masking tape attached to the smooth surface transferring surface 20, it is difficult for the etchant to move toward the smooth surface transferring surface 20. Therefore, there is almost no possibility that the smooth surface transferring surface 20 is etched by the etchant.

Also, when grinding the smooth surface transferring surface 20 by hand, the step surface 21, which is elevated toward the smooth surface transferring surface 20, between the smooth surface transferring surface 20 and the grain processing surface 19, the boundary of the area which is to be ground can be sensed with reliability by the touch. Accordingly, accidental grinding of the grain processing surface 19 can be avoided with reliability.

Note that in the explanation of the embodiment, the example in which the present invention is applied to is a front cover for a vehicle lamp and a mold for molding the front cover for the vehicle lamp. However, the present invention can be widely applied to resin molded products other than the front cover for the vehicle lamp, that is, a resin molded product in which a smooth surface and a grain processing surface are adjacently formed, for example, a lamp body or the like, and molds for molding these products.

Also, the form and the structure of each portion shown in the above-mentioned embodiment are merely examples of embodying the present invention. Accordingly, the technical scope of the present invention must not be construed in a limited manner due to these examples.

As is clear from the above description, a resin molded product according to the present invention including a smooth surface adjacent to a grained surface on which microscopic asperities are formed is characterized in that a step surface which protrudes toward the grained surface is formed on a boundary between the grain processing surface and the smooth surface.

Accordingly, in the resin molded product according to the present invention, the step surface which is positioned on the boundary between the grained surface and the smooth surface allows the boundary between the grained surface and the smooth surface to be seen clearly.

In an embodiment, since the width of the protrusion of the step surface is in a range of 0.01 mm to 0.3 mm, the boundary between the grained surface and the smooth surface can be clearly seen, and refraction of light which impairs the appearance is prevented from being generated.

In another implementation, since the above-mentioned resin molded product is a front cover for a vehicle lamp, the boundary between the grained surface and the smooth surface can be clearly seen. Thus, makes the appearance attractive, and glare light can be prevented from being generated by the step surface.

Also, a mold for molding a resin according to the present invention for molding a resin molded product having a smooth surface adjacent to a grained surface on which microscopic asperities are formed is characterized in that a step surface which protrudes toward the smooth surface transferring surface is formed on the boundary between the grain processing surface for transferring the grained surface and the smooth surface transferring surface for transferring the smooth surface

Accordingly, in the mold for molding a resin according to the present invention, when forming the grain processing surface, an end edge of a portion which becomes the smooth surface transferring surface, that is, on a side of the grain processing surface is at a position higher than the grain processing surface through the step surface. Accordingly, the etchant used for etching microscopic asperities on the grain processing surface is prevented from flowing into a portion which becomes the smooth surface transferring surface by the step surface. Therefore, blurring of the boundary between the smooth surface transferring surface and the grain processing surface can be avoided due to accidental etching of the end edge portion of the portion which becomes the smooth surface transferring surface on the side of the grain processing surface, even if a masking tape is applied to the portion which becomes the smooth surface transferring surface by hand.

Also, since a step surface elevated toward the smooth surface transferring surface exists between the smooth surface transferring surface and the grain processing surface when grinding the smooth transferring surface by hand, a boundary of an area which is to be ground can be sensed with reliability by touch. Accordingly, accidental grinding of the grain processing surface can be avoided with reliability

In another implementation of the invention, the width of the protrusion of the step surface is in a range of 0.01 mm to 0.3 mm, so that the boundary between the smooth surface and the grained surface can be clearly seen in the resin molded product molded using the mold, and refraction of light which impairs the appearance of the step surface is prevented from being generated.

What is claimed is:

1. A resin molded product having a smooth surface adjacent to a grained surface on which microscopic asperities are formed, wherein a step surface which protrudes toward the grained surface is formed on a boundary between the grained surface and the smooth surface.

2. The resin molded product according to claim 1, wherein a width of a protrusion of the step surface is in a range of 0.01 mm to 0.3 mm.

3. The resin molded product according to claim 1, wherein the resin molded product is a front cover for a vehicle lamp.

4. The resin molded product according to claim 2, wherein the resin molded product is a front cover for a vehicle lamp.

5. A mold for molding a resin for forming a resin molded product having a smooth surface adjacent to a grained surface on which microscopic asperities are formed, wherein a step surface which protrudes toward a side of a smooth surface transferring surface is formed on a boundary between a grain processing surface for transferring the grained surface and a smooth surface transferring surface for transferring the smooth surface.

6. The mold for molding a resin according to claim 5, wherein a width of a protrusion of the step surface is in a range of 0.01 mm to 0.3 mm.

7. A resin molded product comprising:
a smooth surface;
a grained surface having microscopic asperities adjacent to the smooth surface; and
a step surface formed at a boundary between the smooth surface and the grained surface, the step surface protruding toward the grained surface at least at the boundary.

8. The resin molding product of claim 7 wherein the thickness of the step surface at the boundary is in a range of 0.01 mm to 0.3 mm.

9. A method for fabricating a mold for molding a resin to have a smooth surface adjacent to a grained surface comprising:
grinding a smooth surface transferring surface until it is smooth;
masking the smooth surface; and
etching a second surface that is recessed at a boundary from the smooth surface transferring surface to form microscopic asperities.
